(19) United States
(12) Patent Application Publication
(10) Pub. No.: US 2023/0170561 A1
(43) Pub. Date: Jun. 1, 2023

(54) MICROBATTERY WITH PRESS FIT

(71) Applicant: Tectus Corporation, Saratoga, CA (US)

(72) Inventor: Michael West Wiemer, San Jose, CA (US)

(21) Appl. No.: 17/903,977

(22) Filed: Sep. 6, 2022

Related U.S. Application Data
(60) Provisional application No. 63/283,946, filed on Nov. 29, 2021.

(51) Int. Cl. H01M 50/166; H01M 50/102

(52) U.S. Cl. CPC H01M 50/166; H01M 50/102

(57) ABSTRACT

A microbattery uses automated machinery and press-fitting to achieve small sizes. The battery has a case with a width of not more than two mm. The case includes a first terminal and a second terminal. A first electrode is electrically connected to the first terminal of the case. A second electrode includes a conductive lip that makes a press fit contact to the case, whereby the second electrode is electrically connected to the second terminal of the case.

### CROSS-REFERENCE TO RELATED APPLICATION(S)

This application claims priority under 35 U.S.C. § 119(e) to U.S. Provisional Patent Application Ser. No. 63/283,946, “Contact Lens Battery,” filed Nov. 29, 2021. The subject matter of all of the foregoing is incorporated herein by reference in their entirety.

### BACKGROUND

### 1. Technical Field

This disclosure relates generally to batteries.

### 2. Description of Related Art

Conventional batteries do not meet all the requirements for contact lens batteries in part because they are too big, do not store enough electrical energy, or both. Conventional battery assembly techniques also leave too much dead space inside a battery cell. In some cases only 15% of the volume of a conventional battery is devoted to producing electrical output.

### BRIEF DESCRIPTION OF THE DRAWINGS

Embodiments of the disclosure have other advantages and features which will be more readily apparent from the following detailed description and the appended claims, when taken in conjunction with the examples in the accompanying drawings, in which:

FIG. 1 is a perspective view of a contact lens containing batteries and electronic modules.

FIG. 2 is a cross-sectional view of a three-terminal contact lens battery.

FIGS. 3A-3E are cross-sectional views showing assembly of a three-terminal contact lens battery.

### DETAILED DESCRIPTION OF THE PREFERRED EMBODIMENTS

The figures and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Contact lens batteries are designed to reduce wasted space, support a high electrical energy density, and fit inside a contact lens. Advanced battery structures and manufacturing techniques described herein make these goals possible. In fact, the advanced structures may be designed with specific manufacturing techniques in mind.

In one battery architecture, the layers (e.g. anode, cathode, separator, etc.) of a battery are placed or press-fit into a battery case with a pick-and-place machine, for example to form a three-terminal, double-cell battery. This results in compact batteries suitable for use in contact lenses.

Modern pick-and-place machines (the Manncorp MC389 is one example among many) can place more than 10,000 surface mount technology (SMT) electronic parts per hour with 30 micron (3 Sigma) placement accuracy. Such machines, or customized industrial robots may be used to assemble contact lens batteries because humans cannot manipulate the small parts of the batteries accurately enough.

Precision robotic assembly techniques allow the manufacture of advanced battery architectures. The resulting batteries are small enough to fit inside a contact lens that is wearable by a human. The battery designs take advantage of the robots' (and machine tools') ability to register themselves against alignment marks. This allows precise placement of components and machining around parts hidden under metal layers, for example.

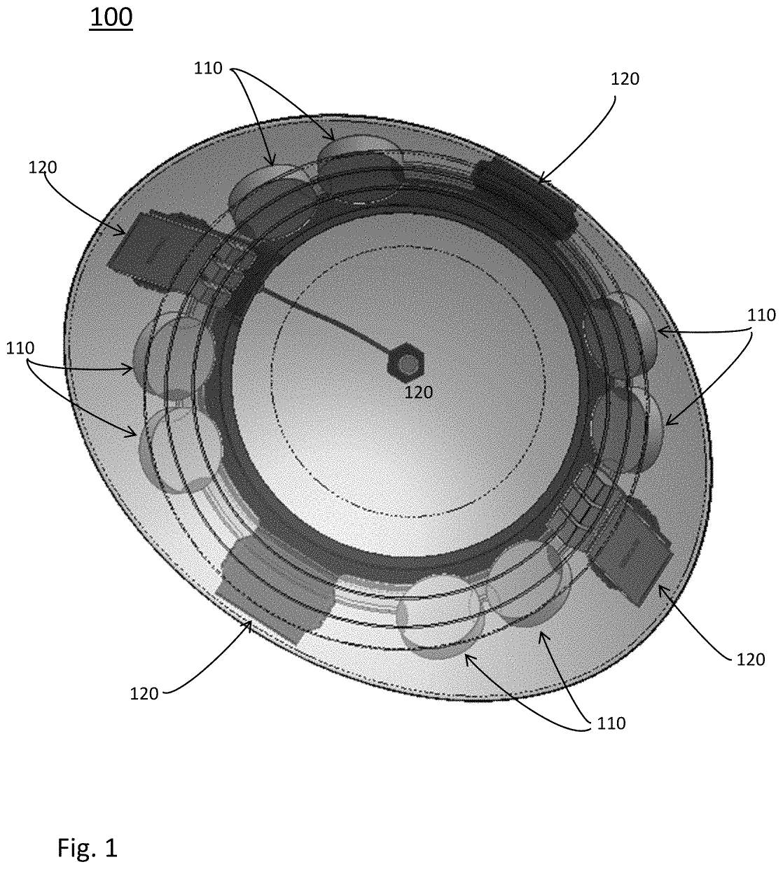

FIG. 1 is a perspective view of a contact lens containing batteries and electronic modules. FIG. 1 shows an electronic contact lens, as seen from the posterior side. The lens contains an electronic payload 120, including in this example, radio communications, data processing, and image projection modules. In this lens, eight cylindrical batteries 110 provide electrical power. However, the batteries need not be cylindrical. In other designs, they may be made in other shapes such as squares, trapezoids, or complicated geometries that fit the space available in the lens.

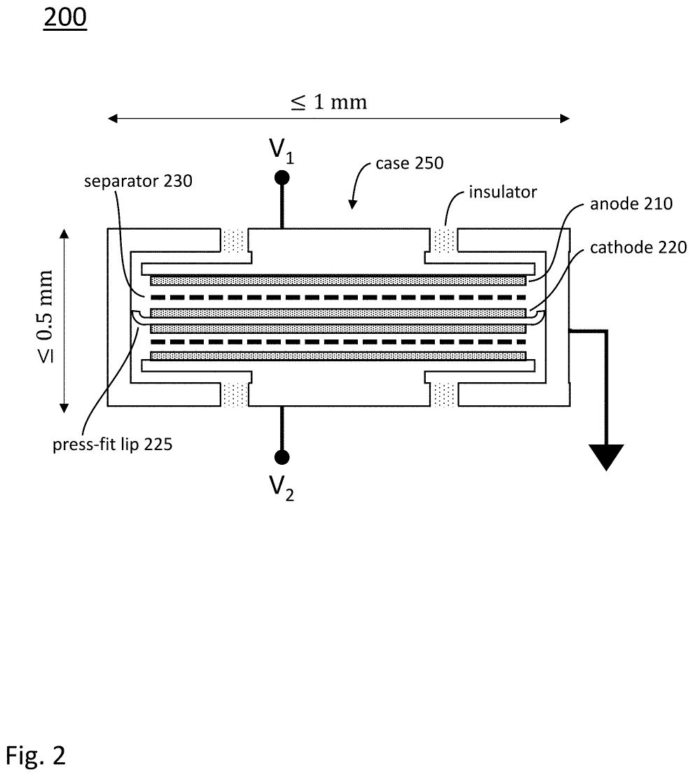

FIG. 2 is a cross-sectional view of a three-terminal contact lens battery 200. Such a battery may be less than 1 mm thick or even less than 0.5 mm thick. It may be less than 2 mm wide or even less than 1 mm wide. However, such measurements are not limiting. The battery is thin enough to fit inside a contact lens. Layers of the battery, such as the anode 210, cathode 220 and separator 230 are assembled in the outer case 250 using high precision pick-and-place tools or robots. The middle conductor, with cathode material 220 on either side, has a press-fit lip 225 which is press-fit into the case 250. Anode 210 and cathode 220 material may be swapped to create a battery of the opposite polarity. Anode and cathode material is deposited on metal foil before assembly into a battery cell. Metal conductive foil provides electrical contact between the battery case and the electrode. In this example, the electrodes 210, 220 and separators 230 are flat, although they may be curved in other designs. The cathode has a smaller surface area than the anode in most cases. In this design, cells providing V₁ and V₂ are independent. A fault in one battery cell does not affect the other, for example.

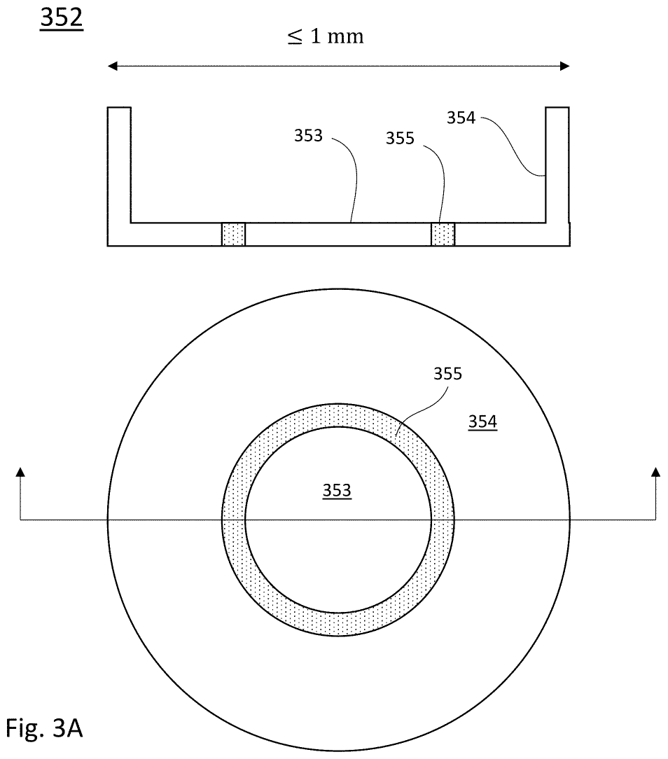

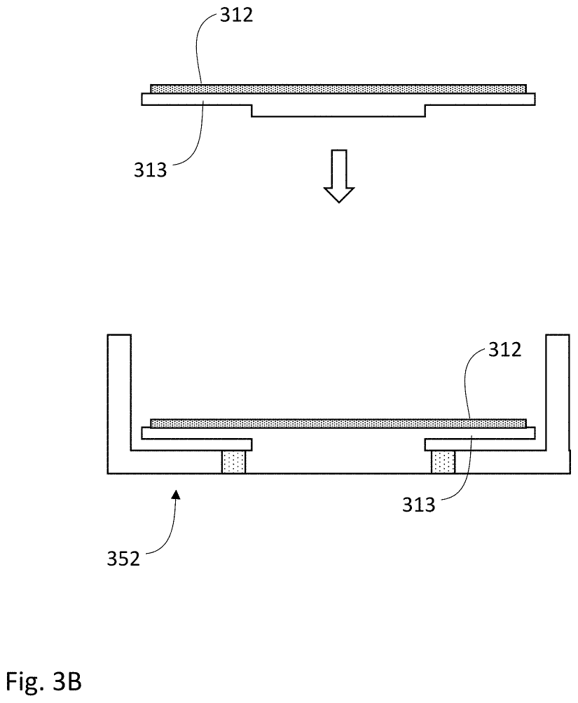

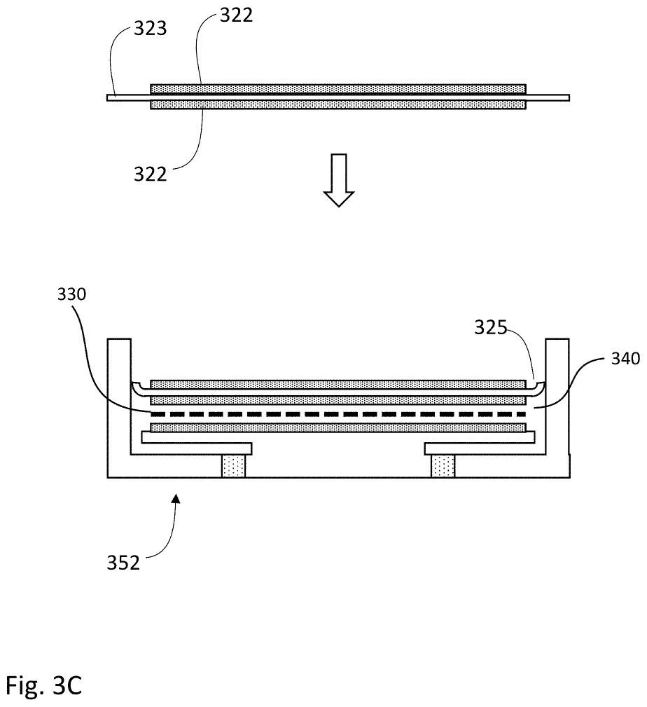

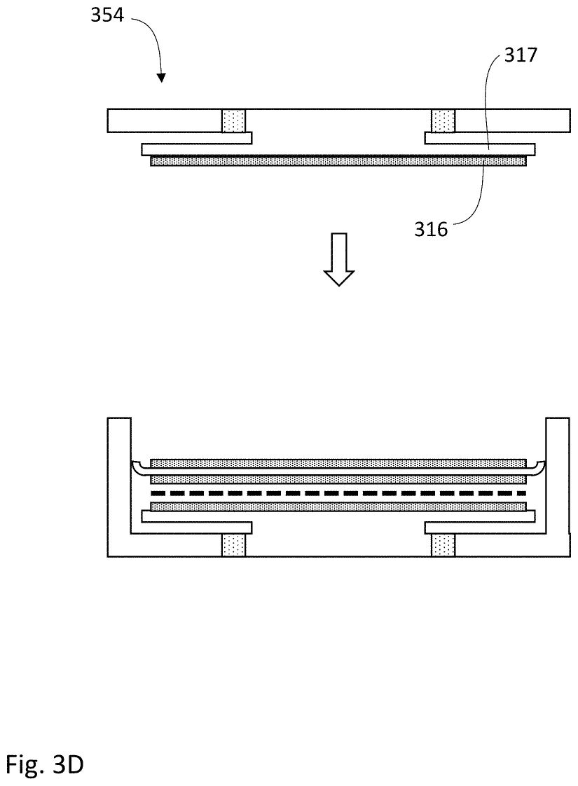

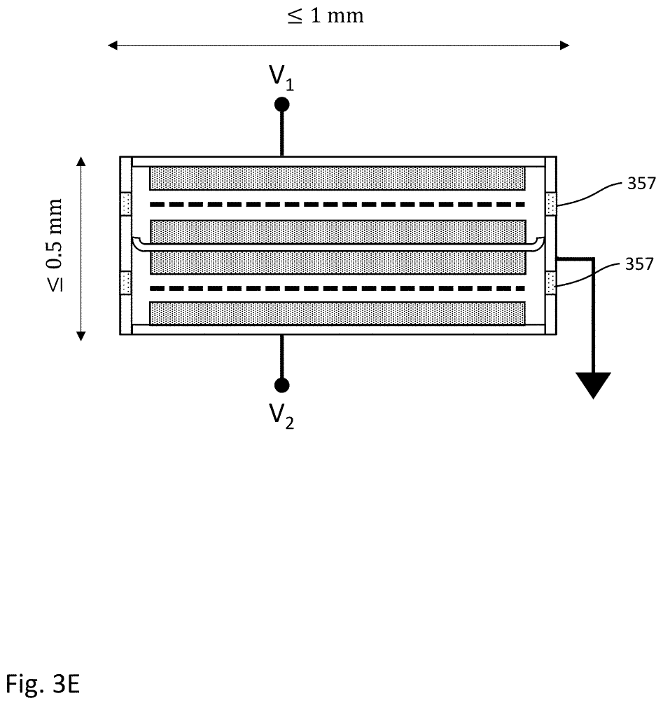

FIGS. 3A-3E are cross-sectional views showing assembly of a three-terminal contact lens battery. FIG. 3A shows cross-sectional and end views of a contact lens battery shell 352 in preparation for battery assembly. Although this battery is cylindrical, other shapes such as multi-sided boxes are acceptable and may be preferred depending on the application. For example, the shape may be adapted to fit into an available volume. The battery shell has two conductive regions 353, 354 separated by an insulating region 355. To fit in a contact lens the overall dimensions of the battery are roughly 1×1×1 mm in this example. One or two dimensions may be larger than that, but the thickness of the contact lens may restrict the third dimension to be less than 1 mm.

FIG. 3B shows electrode material 312 mounted on a conductive carrier 313. The assembly is then fused to the battery shell 352, as shown in the bottom of FIG. 3B. The electrode material 312 may be carbon, lithium, lithium cobalt oxide (LCO), nickel cobalt manganese (NCM) or nickel cobalt aluminum (NCA) as examples. The conductive carrier 313 may be placed in the shell 352 with a high accuracy pick-and-place machine or industrial robot. Such machines can place thousands of parts per hour with better than 30-micron accuracy. The gap between the carrier 313 and the shell 352may therefore be as little as 100 microns or less.

FIG. 3C shows electrode material 322 mounted on a flexible conductive carrier 323. The assembly is then press fit 325 into the battery shell 352 using pick-and-place or robotic techniques, as shown in the bottom of FIG. 3C. The electrode material 322 may be carbon, lithium, lithium cobalt oxide (LCO), nickel cobalt manganese (NCM) or nickel cobalt aluminum (NCA) as examples, depending on whether it is an anode or cathode. An electrolyte 340 may be introduced between the configurations of FIGS. 3B and 3C. The electrolyte is a mixture of an organic compound(s) such as ethylene carbonate, dimethyl carbonate (DMC), ethyl methyl carbonate (EMC), or diethyl carbonate (DEC) and a salt such as LiPF₆ (lithium hexafluorophosphate). A porous polypropylene or polyethylene separator 330 allows ions to pass, but prevents the anode and cathode from touching one another.

In FIG. 3D, a second shell end 354 is prepared with a second conductive carrier 317 and electrode material 316.

As shown in FIG. 3E, when the second shell end 354 is fused with the structure of FIG. 3D, the result is a completed battery, similar to the battery shown in FIG. 2. This FIG. 3E shows a variation in which the case insulation 357 separating the poles of the battery is located in the side of the case rather than the ends. The battery comprises two cells which are electrically and physically independent.

Although the detailed description contains many specifics, these should not be construed as limiting the scope of the invention but merely as illustrating different examples. It should be appreciated that the scope of the disclosure includes other embodiments not discussed in detail above. Various other modifications, changes and variations which will be apparent to those skilled in the art may be made in the arrangement, operation and details of the method and apparatus disclosed herein without departing from the spirit and scope as defined in the appended claims. Therefore, the scope of the invention should be determined by the appended claims and their legal equivalents.

What is claimed is:

1. A microbattery comprising:
a case having a width of not more than two mm, the case including a first terminal and a second terminal;
a first electrode that is electrically connected to the first terminal of the case; and
a second electrode having a conductive lip that makes a press fit contact to the case, whereby the second electrode is electrically connected to the second terminal of the case.

2. The microbattery of claim 1 wherein the first electrode comprises first electrode material mounted on a conductive carrier that contacts a base of the case.

3. The microbattery of claim 1 wherein the second electrode comprises second electrode material mounted on a conductive carrier, and the conductive lip is part of the conductive carrier.

4. The microbattery of claim 1 further comprising:
a separator between the first electrode and the second electrode.

5. The microbattery of claim 1 wherein the case comprises an insulator on a bottom of the case that electrically separates the first terminal and the second terminal of the case.

6. The microbattery of claim 1 wherein the case comprises an insulator on a side of the case that electrically separates the first terminal and the second terminal of the case.

7. The microbattery of claim 1 wherein the case further includes a third terminal, the microbattery further comprising:
a third electrode that is electrically connected to the third terminal of the case; wherein the first electrode and the second electrode form a first battery cell having the first terminal and second terminal as terminals, and the second electrode and the third electrode form a second battery cell having the second terminal and third terminal as terminals.

8. The microbattery of claim 5 wherein the first and second battery cells are independent of each other.

9. The microbattery of claim 1 wherein the case has a thickness of not more than one mm.

10. The microbattery of claim 1 wherein the case is small enough to fit into an electronic contact lens.

11. A microbattery comprising:
a case comprising a base, a side and a cap, the base of the case including a first terminal, the side of the case including a second terminal, and the cap of the case including a third terminal;
a battery stack inside the case, the battery stack comprising, in order from the base to the cap:
a flat first electrode comprising first electrode material mounted on a first conductive carrier that contacts the base of the case, so that the first electrode is electrically connected to the first terminal;
a flat first separator;
a flat second electrode comprising second electrode material mounted on both sides of a flexible second conductive carrier that has a conductive lip that contacts the side of the case, so that the second electrode is electrically connected to the second terminal;
a flat second separator; and
a flat third electrode comprising third electrode material mounted on a third conductive carrier that contacts the cap of the case, so that the third electrode is electrically connected to the third terminal of the case;
wherein the first and third electrodes are both either anode or cathode, and the second electrode is the other of anode or cathode; and
an electrolyte occupying an interior of the case.

12. The microbattery of claim 11 wherein:
the electrodes comprise at least one of carbon, lithium, lithium cobalt oxide, nickel cobalt manganese or nickel cobalt aluminum;
the electrolyte comprises a mixture of an organic compound and a salt; and
the separators comprise at least one of a porous polypropylene or polyethylene separator.

13. The microbattery of claim 11 wherein the battery stack occupies more than fifteen percent (15%) of an interior volume of the case.

14. A method for assembling a microbattery, the method comprising automated machinery performing the following steps:
inserting a first component into a case having a first terminal and a second terminal and having a width of not more than two mm; the first component containing a first electrode, wherein the first electrode is electrically connected to the first terminal when the first component is inserted into the case; and
press fitting a second component into the case and onto the first component; the second component containing a second electrode having a conductive lip, wherein the press fit makes contact between the conductive lip and the case so that the second electrode is electrically connected to the second terminal.

15. The method of claim 14 wherein the automated machinery comprises a pick and place machine.

16. The method of claim 14 wherein inserting the first component into the case results in a gap between the first component and the case of not more than 100 um.

17. The method of claim 14 further comprising:
depositing first electrode material onto a first metal foil to form the first electrode; and
depositing second electrode material onto a second metal foil to form the second electrode.

18. The method of claim 14 wherein the first electrode comprises first electrode material mounted on a conductive carrier; and inserting the first component into the case comprises fusing the conductive carrier to the case.

19. The method of claim 14 wherein the case has a third terminal; and the steps performed by the automated machinery further comprise:
placing a third component onto the second component, the third component containing a third electrode; wherein the third electrode is electrically connected to the third terminal, and the first and third electrodes are both either anode or cathode, and the second electrode is the other of anode or cathode.

20. The method of claim 19 wherein the case has a bottom part comprising a base and a side, the base of the case includes the first terminal, and the side of the case includes the second terminal;
inserting the first component into the case comprises: inserting the first component into the bottom part of the case; the first electrode comprising first electrode material mounted on a first conductive carrier, wherein the first conductive carrier makes contact with the base of the case so that the first electrode is electrically connected to the first terminal of the case;
press fitting the second component into the case and onto the first component comprises:
press fitting the second component into the bottom part of the case and onto the first component; the second electrode comprising second electrode material mounted on both sides of a flexible second conductive carrier that has the conductive lip, wherein the press fit makes contact between the conductive lip and the side of the case so that the second electrode is electrically connected to the second terminal;
placing the third component onto the second component comprises: attaching a top subassembly to the bottom part of the case, the top subassembly comprising a top part of the case and the third component, the top part comprising a cap of the case that includes the third terminal, the third electrode comprising third electrode material mounted on a third conductive carrier, wherein the third conductive carrier makes contact with the cap of the case so that the third electrode is electrically connected to the third terminal;
